(19) United States
(12) Patent Application Publication
(10) Pub. No.: US 2012/0326870 A1
(43) Pub. Date: Dec. 27, 2012

(54) DEVICE FOR PREVENTION OF CARD DISPLACEMENT

(76) Inventors: Asaf Horev, Rishon Le-Tzion (IL); Guy LEVIN, Tel-Aviv (IL)

(21) Appl. No.: 13/582,737

(22) PCT Filed: Mar. 20, 2011
(86) PCT No.: PCT/IB2011/000577

§ 371 Date: Sep. 4, 2012

Related U.S. Application Data
(60) Provisional application No. 61/315,972, filed on Mar. 21, 2010.

(51) Int. Cl. G08B 13/14; F16B 2/22

(52) U.S. Cl. 340/568.7; 24/578.17; 24/485

(57) ABSTRACT

According to embodiments of the present invention, there is provided a device for prevention of card displacement. The device includes a holding element at least partially formed of electrically conductive material; a board including an electric circuit, an alarm element and a power source that is operatively associated with the electric circuit and the alarm element. The holding element is coupled to the board such that at least some of the electrically conducting material of the holding element is pressed by default against the board, such that adjustment of a card between the holding element and the board opens the electric circuit and wherein removal of the card therefrom closes the electric circuit and thereby activates the alarm element.

### REFERENCE TO RELATED APPLICATIONS

Reference is made to U.S. Provisional Patent Application Ser. No. 61/315,972, filed Mar. 21, 2010 and entitled “DEVICE FOR THE PREVENTION OF UNINTENTIONAL DISENGAGEMENT OF A CARD FROM A PURSE”.

### TECHNICAL FIELD

The present invention generally relates to, but is not limited to, the field of a device for use in a purse or card holder and in particular to a device for alarming a card owner of a displaced card.

### BACKGROUND

The following publications are believed to represent the current state of the art:

U.S. Pat. Nos. 5,125,356; 5,790,027; 5,914,657; 4,692,745; 6,876,301; 5,418,520; 6,648,038; 6,963,276; 5,034,724; 6,184,788; 4,719,453; 5,053,749; 4,916,434; 4,717,908; 3,959,789; 5,373,283; 3,930,249; 4,480,250; 4,652,865.

### SUMMARY

The present invention seeks to provide an improved device for prevention of card displacement.

There is thus provided in accordance with a preferred embodiment of the present invention a device for prevention of card displacement, including a holding element at least partially formed of electrically conductive material; a board, wherein the board includes: an electric circuit; an alarm element; and a power source that is operatively associated with said electric circuit and said alarm element; wherein the holding element is coupled to the board such that at least some of the electrically conducting material of the holding element is pressed by default against the board.

There is further provided in accordance with an additional embodiment of the present invention a device for prevention of card displacement, including a holding element at least partially formed of electrically conductive material; a board, wherein the board includes: an electric circuit; an alarm element; and a power source that is operatively associated with the electric circuit and the alarm element; wherein the device for prevention of card displacement is operative in an electrically closed position wherein the holding element is coupled to the board such that at least some of the electrically conducting material of the holding element is pressed by default against the board and in an electrically open position wherein the holding element and the board are generally spaced apart.

There is further provided in accordance with yet an additional embodiment of the present invention a device for prevention of card displacement, including a holding element at least partially formed of electrically conductive material; a board, wherein the board includes: an electric circuit; an alarm element; and a power source that is operatively associated with the electric circuit and the alarm element; wherein the holding element is coupled to the board such that at least some of the electrically conducting material of the holding element is pressed by default against the board, such that adjustment of the card between the holding element and the board opens the electric circuit; and wherein removal of the card therefrom closes the electric circuit.

These and other aspects and features of non-limiting embodiments of the present invention will now become apparent to those skilled in the art upon review of the following description of specific non-limiting embodiments of the invention in conjunction with the accompanying drawings.

### DESCRIPTION OF THE DRAWINGS

The present invention will be understood and appreciated more fully from the following detailed description, taken in conjunction with the drawings in which:

FIG. 1 is a simplified pictorial illustration of a device for prevention of card displacement constructed and operative in accordance with a preferred embodiment of the invention;

FIG. 2 is a simplified pictorial exploded view illustration of the device for prevention of card displacement constructed and operative in accordance with another preferred embodiment of the invention;

FIG. 3A is a simplified schematic illustration of the device for prevention of card displacement of FIG. 2, inserted into a first exemplary purse;

FIG. 3B is a simplified schematic illustration of the device for prevention of card displacement of FIG. 2, inserted into a second exemplary purse;

FIG. 4 is a simplified pictorial illustration of the device for prevention of card displacement constructed and operative in accordance with yet another preferred embodiment of the invention;

FIG. 5 is a simplified pictorial cut away view illustration of the device for prevention of card displacement of FIG. 4, shown without the holding portion;

FIG. 6 is a simplified pictorial exploded view illustration of the device for prevention of card displacement of FIG. 4;

FIG. 7 is a simplified pictorial illustration of the device for prevention of card displacement constructed and operative in accordance with yet another preferred embodiment of the invention.

The drawings taken with description make apparent to those skilled in the art how the invention may be embodied in practice.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate identical elements.

### DESCRIPTION OF THE NON-LIMITING EMBODIMENTS

The present invention discloses a device and a method that enables, inter alia, prevention of a card such as, for example, of a credit card displacement from a purse or other carrying means. Displacement prevention may be accomplished by triggering an alarm element in the event of an attempt of unauthorized removal of the card from the purse and/or in the event that the card falls out from the purse or is not returned thereto.

It should be understood that the term “purse” as used herein may refer to any kind of accessory in which card or other type of cards may be stored. Accordingly, a purse may refer, for example, to a wallet, a billfold, a pocketbook, a handbag, a carryon, a pocket or any other carrying device.

An embodiment is an example or implementation of the invention. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions.

It is understood that the phraseology and terminology employed herein is not to be construed as limiting, and is for descriptive purpose only.

The principles and uses of the teachings of the present invention may be better understood with reference to the accompanying description, figures and examples.

It should be understood that the details set forth herein do not construe a limitation to an application of the invention. Furthermore, it should be understood that the invention can be carried out or practiced in various ways and that the invention can be implemented in embodiments other than the ones outlined in the description below.

It should be understood that the terms “including”, “comprising”, “consisting” and grammatical variants thereof do not preclude the addition of one or more components, features, steps, integers or groups thereof and that the terms are not to be construed as specifying components, features, steps or integers.

If the specification or claims refer to “an additional” element, that does not preclude there being more than one of the additional element.

It should be understood that where the claims or specification refer to “a” or “an” element, such reference is not to be construed as there being only one of that element.

It should be understood that where the specification states that a component, feature, structure, or characteristic “may”, “might”, “can” or “could” be included, that particular component, feature, structure, or characteristic is not required to be included.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

Any publications, including patents, patent applications and articles, that may be referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

The terms “bottom”, “below”, “top” and “above” and the like that may be specified herein do not necessarily indicate that a “bottom” component is below a “top” component, or that a component that is “below” is indeed “below” another component or that a component that is “above” is indeed “above” another component as such directions, components or both may be flipped, rotated, moved in space, placed in a diagonal orientation or position, placed horizontally or vertically, or similarly modified. Accordingly, it will be appreciated that, for example, the terms “bottom”, “below”, “top” and “above” may be used herein for exemplary purposes only, to illustrate the relative positioning or placement of certain components, to indicate a first and a second component or to do both such as when viewing them in the figures.

It should be understood that, unless otherwise indicated, the term “couple”, “coupled”, “coupling” and grammatical variations thereof as used herein, refers to the mechanical coupling between a plurality of elements, wherein the mechanical coupling between the plurality of elements may refer to an embodiment in which the different elements are substantially fixedly coupled to each other, as well as to another embodiment in which the plurality of elements may be integrally formed with each other.

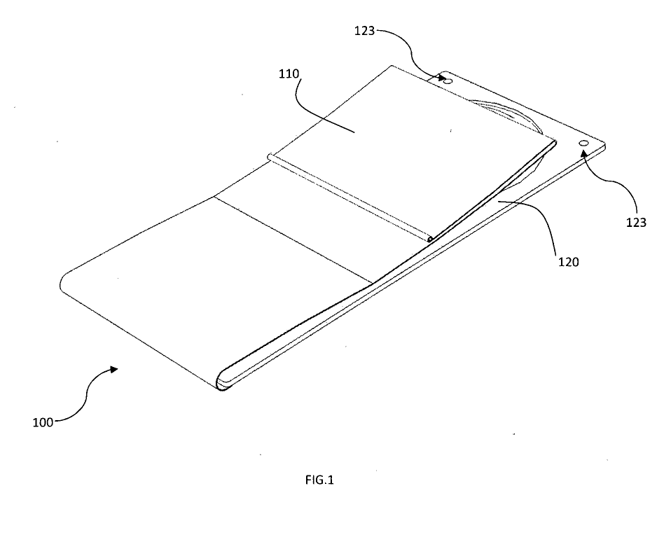

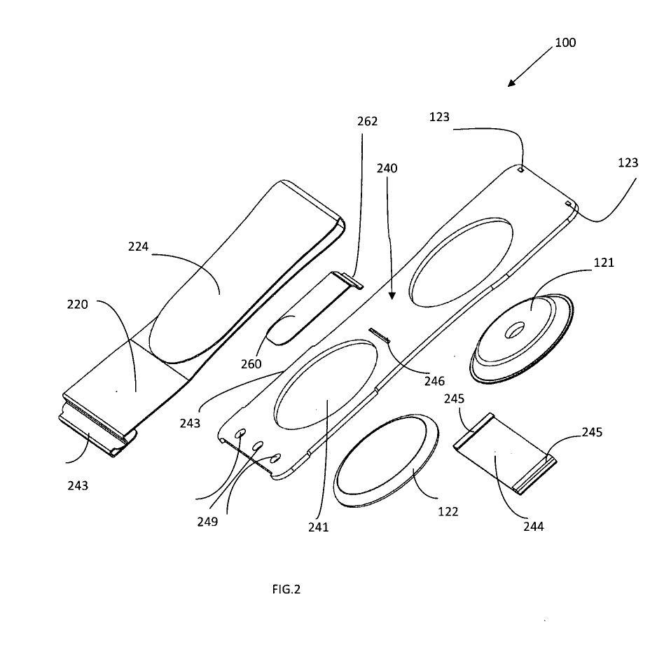

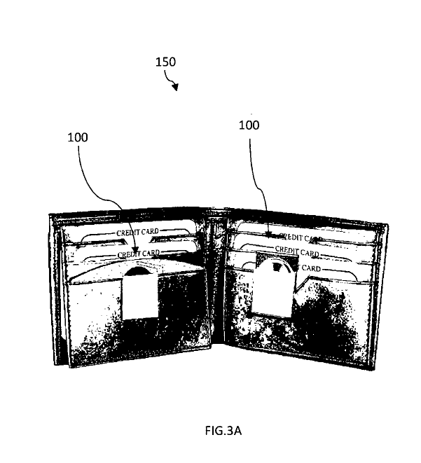

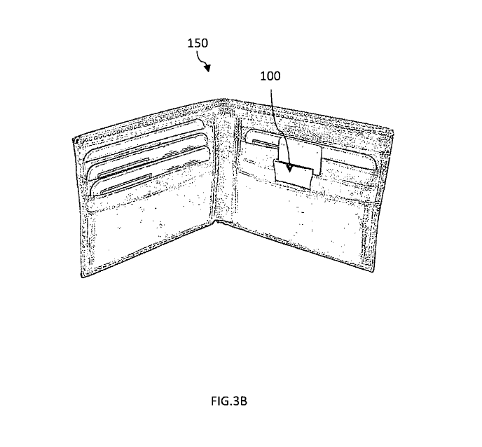

Reference is now made to FIG. 1, FIG. 2, FIG. 3A and to FIG. 3B. According to some embodiments of the invention, a device for prevention of card displacement 100 may include a holding portion 110 that is coupled to a board 120 that may include an electric circuit (not shown). The board 120 may be formed of a printed circuit board (PCB), e.g., as it is known in the art. The holding portion 110 may be made out of a flexible or resilient material, wherein at least some portion of the holding portion 110 may include an electrically conducting material. Furthermore, the board 120 may include a power source 122 and an alarm element 121, which may be operatively linked to, for example, one or more light emitting diodes (LEDs) 123. In some embodiments of the invention, the power source 122 may also be operatively associated with the electric circuit and the alarm element 121.

In an embodiment of the invention, the holding portion 110 may be coupled and/or flexed such that at least some of the electrically conducting material thereof is by default pressed against the power source 122, thereby closing the electric circuit. The closing of the electric circuit triggers in response the alarm element 121, which may issue, for example, a vibration of the device for prevention of card displacement 100 and/or an audible signal and/or a visual signal (via, e.g., LEDs 123).

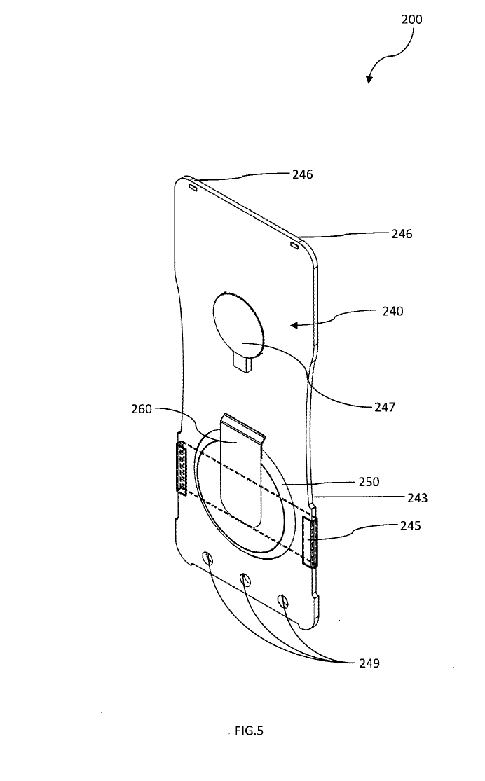

In an embodiment of the invention, a card (not shown) may be adjusted between the holding portion 110 and the board 120 of the device for prevention of card displacement 100. Furthermore, the device for prevention of card displacement 100 may be positioned within a compartment of a purse 150. Thusly, removal of the card from the device for prevention of card displacement 100 results in closing of the electric circuit which results in triggering the alarm element 121 and/or 123 and/or 247 as further shown in FIG. 5. Consequently, the owner of the purse 150 is notified of the removal of the card from the device for prevention of card displacement 100.

According to some embodiments of the invention, the device for prevention of card displacement 100 may include a delay function. The delay function may cause the triggering of the alarm element 121 and/or 123 and/or 247 only a predetermined time after the closing of the electric circuit. For example, triggering of the alarm element 121 and/or 123 and/or 247 may occur, for example, only 20 seconds, 30 seconds, 40 seconds, 60 seconds, 120 seconds and the like, after the electric circuit has been closed. Consequently, not returning of the card within the predetermined time causes the triggering of the alarm element 121 and/or 123 and/or 247, thereby notifying the user of the device for prevention of card displacement 100 of possible unintentional displacement (e.g., due to theft, falling out or inadvertently misplace) of the card from the purse 150. Conversely, returning the card within the predetermined time and placing it between the holding portion 110 and the board 120 reopens the electric circuit, wherein the returning of the card neutralizes the alarm element 121 and/or 123 and/or 247. Furthermore, reopening of the electric circuit may naught the delay function. Correspondingly, the time that is required to trigger the alarm element 121 and/or 123 and/or 247 after reclosing the electric circuit may again be measured according to the abovementioned predetermined time.

It should be understood that the delay function may be implemented by hardware and/or software.

According to some embodiments of the invention, the device for prevention of card displacement 100 includes a mechanism (not shown) for neutralizing the alarm element 121 and/or 123 and/or 247. The neutralizing mechanism may only be known and/or accessible by the user of the device for prevention of card displacement 100. Correspondingly, the user may remove the card from the purse 150 without triggering the alarm element 121.

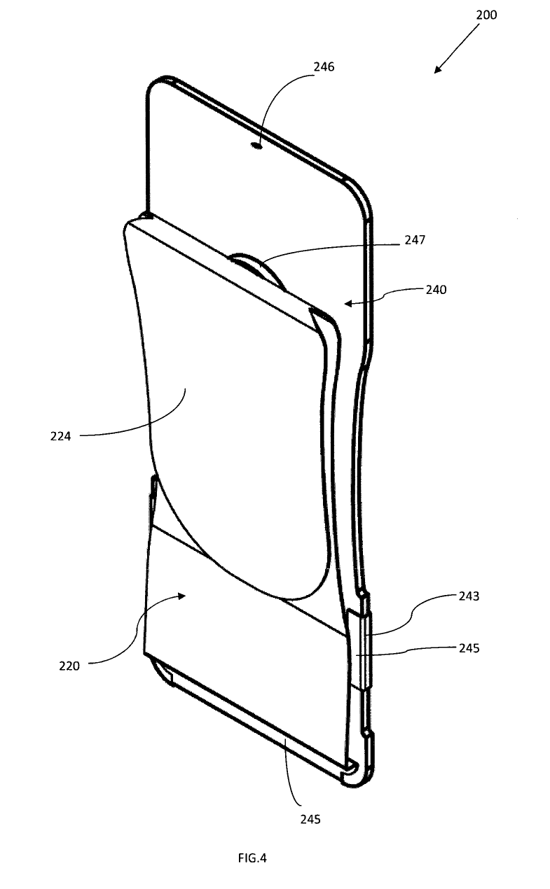

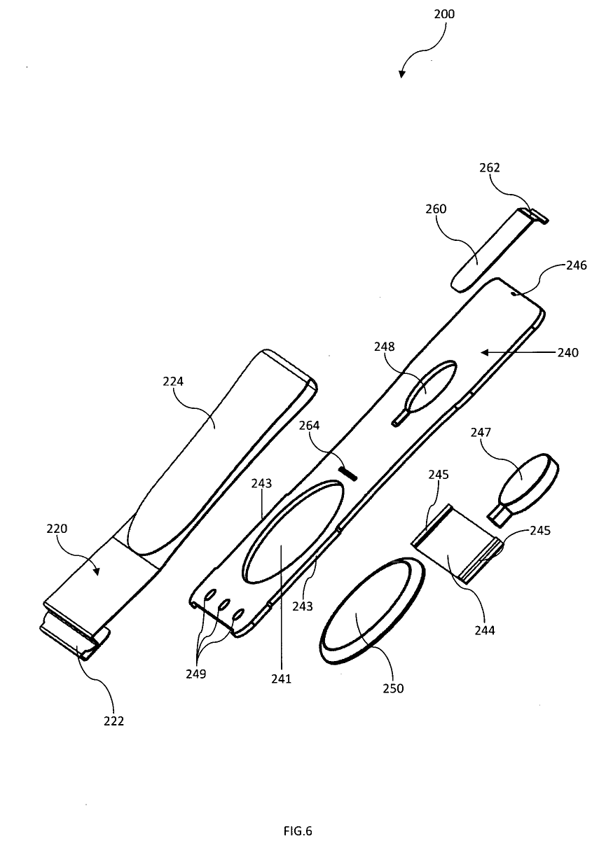

Reference is now made to FIG. 4, FIG. 5 and FIG. 6. According to yet another embodiment of the invention, a device for prevention of card displacement 200 may include a holding portion 220 that is coupled to a board 240 by means of portion 222 and is additionally hingedly or by means of bended sheet or equivalently otherwise coupled with a clamping portion 224 which is facilitating the adjustment of the device into the purse 150 or carrying device alike. The board 240 may be formed of a printed circuit board (PCB) or a plastic board, e.g., as known in the art. The holding portion 220 along with the clamping portion 224 may be made out of a flexible or resilient material, wherein at least some portion of the holding portion 220 may include an electrically conducting material. Furthermore, the board 240 may include a power source 250 and an alarm element 247, which may be operatively linked to, for example, one or more light emitting diodes (LEDs) 246. In some embodiments of the invention, the power source 250 may also be operatively associated with the electric circuit and the alarm element 247.

In an embodiment of the invention, the sheet 220 may be coupled and/or flexed such that at least some of the electrically conducting material thereof is by default pressed against the board 240, thereby closing the electric circuit. The closing of the electric circuit triggers in response the alarm element 247, which may issue, for example, a vibrating alarm along with visual signal (via, e.g., LEDs 246) or just one of said types of alarm.

In an embodiment of the invention, a card (not shown) may be adjusted between the holding portion 220 and the board 240 of the device for prevention of card displacement 200. Furthermore, the device for prevention of card displacement 200 may be positioned within a compartment of the purse 150, as shown in FIG. 3, by means of the clamping portion 224. Thusly, removal of the card from the device for prevention of card displacement 200 results in closing of the electric circuit which results in triggering the alarm element 247 and/or 246. Consequently, the owner of the purse 150 is notified of removal of the card from the purse 150.

According to some embodiments of the invention, the device for prevention of card displacement 200 may include a delay function. The delay function may cause the triggering of the alarm element 247 and/or 246 only a predetermined time after the closing of the electric circuit. For example, triggering of the alarm element 247 along with the alarm element 246 or just one of the alarm types may occur, for example, only 20 seconds, 30 seconds, 40 seconds, 60 seconds, 120 seconds and the like, after the electric circuit has been closed. Consequently, not returning of the card within the predetermined time causes the triggering of the alarm element 247 and/or 246, thereby notifying the carrier of the device for prevention of card displacement 200 of possible unintentional displacement (e.g., due to theft or due to falling out) of the card from the device for prevention of card displacement 200. Conversely, returning the card within the predetermined time between the sheet 220 and the board 240 reopens the electric circuit, wherein the returning of the card neutralizes the alarm element 247 and/or 246. Furthermore, reopening of the electric circuit may naught the delay mechanism. Correspondingly, the time that is required to trigger the alarm element 247 and/or 246 after reclosing the electric circuit may again be measured according to the abovementioned predetermined time.

It should be understood that the delay function may be implemented by hardware and/or software.

According to some embodiments of the invention, the device for prevention of card displacement 200 includes a mechanism (not shown) for neutralizing the alarm element 247 and/or 246. The neutralizing mechanism may only be known and/or accessible by the user of the device for prevention of card displacement 200. Correspondingly, the user may remove the payment means from the purse 150 without triggering the alarm element 247 and/or 246.

Reference is now made to FIG. 6, exemplary design of the board 240 can be seen, while it includes an opening 241 suitable for the insertion of the power source 250. The power source 250 is inserted within the opening 241 and is held within by means of a substantially planar flange 244. The planar flange includes two opposed and spaced arms 245, which hold the planar flange 244 on a portion 243 of the board 240. The spaced arms 245 of the planar flange 244 are slidable over the portion 243 of the board 240. There is also provided a holding tab 260 having a connecting portion 262 and a receiving aperture 264. The receiving aperture 264 is positioned on the board 240 and the connecting portion 262 of the holding tab 260 is fixedly inserted within the receiving aperture 264. The power source 250, while positioned within the opening 241, is held from one side by the planar flange 244 and from the other side by the holding tab 260. The planar flange 244 is slidable over the board 240 and thereby when the planar flange does not support the power source 250, the power source 250 can be readily removed from the device for prevention of card displacement 200.

The board 240 further optionally includes an alarm opening 248 suitable to receive thereto the alarm element 247, such as a vibrating motor. The board 240 further optionally includes light emitting diodes (LEDs) 246. The board has at least one hole 249 at one end thereof adapted to be attached with portion 222 of the holding portion 220.

According to an embodiment of the invention the device for prevention of card displacement 200 can be produced of various configurations such as to be adapted to various purse/wallet existing designs, such as various width and length purse constructions.

It should be understood that the device could comprise one or several alarm means as described and referenced by figures of this invention. For example, vibration alarm only or visual alarm (e.g. LEDs) only can be provided on the theft prevention device as well as both types of alarm means or other audible alarm as described in FIGS. 1-4.

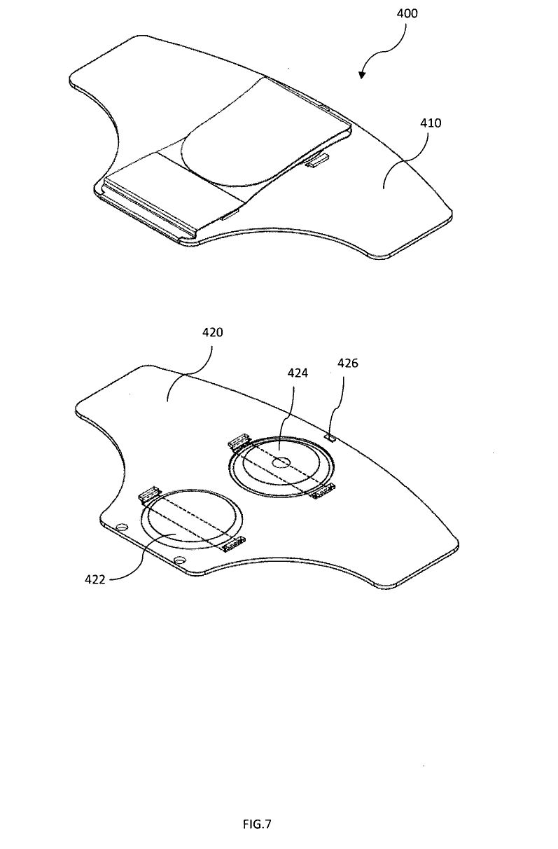

Reference is now made to FIG. 7. According to some embodiments of the invention, the device for prevention of card displacement may have various shapes. For example, the device for prevention of card displacement 400 may include a board 420 that may have a butterfly shape, and a holding element 410, which may be of any geometrical configuration. The device for prevention of card displacement 400 may further include, similarly to the previously shown embodiments a power source 422, an alarm element 424 and LED's 426, which are operative similarly to the previously shown embodiments.

The shape of the device for prevention of card displacement 400 may facilitate the adjustment of the device for prevention of card displacement 400 into a compartment of the purse 150 (shown in FIGS. 3A and 3B).

It should be understood that some embodiments of the invention may be implemented, for example, using a machine-readable medium or article which may store an instruction or a set of instructions that, if executed by a machine, cause the machine to perform a method or operations or both in accordance with embodiments of the invention. Such a machine may include, for example, any suitable processing platform, computing platform, computing device, processing device, computing system, processing system, computer, processor, or the like, and may be implemented using any suitable combination of hardware or software or both. The machine-readable medium or article may include but is not limited to, any suitable type of memory unit, memory device, memory article, memory medium, storage article, storage device, storage medium or storage unit such as, for example, memory, removable or non-removable media, erasable or non-erasable media, writeable or re-writeable media, digital or analog media, optical disk, hard disk, floppy disk, magnetic media, and/or the like. The instructions may include any suitable type of code, for example, an executable code, a compiled code, a dynamic code, a static code, interpreted code, a source code or the like, and may be implemented using any suitable high-level, low-level, object-oriented, visual, compiled or interpreted programming language. Such a compiled or interpreted programming language may be, for example, C, C++, C#, .Net, Java, Pascal, s, BASIC, Cobol, Fortran, assembly language, machine code and the like.

Description of the non-limiting embodiments of the present inventions provides examples of the present invention, and these examples do not limit the scope of the present invention. It is to be expressly understood that the scope of the present invention is limited by the claims. The concepts described above may be adapted for specific conditions and/or functions, and may be further extended to a variety of other applications that are within the scope of the present invention. Having thus described the non-limiting embodiments of the present invention, it will be apparent that modifications and enhancements are possible without departing from the concepts as described. Therefore, what is to be protected by way of letters patent are limited only by the scope of the following claims:

What is claimed is:

1. A device for prevention of card displacement, comprising:
a holding element at least partially formed of electrically conductive material;
a board, wherein said board comprises:
an electric circuit;
an alarm element; and
a power source that is operatively associated with said electric circuit and said alarm element;
wherein said holding element is coupled to said board such that at least some of the electrically conducting material of said holding element is pressed by default against said board.

2. A device for prevention of card displacement, comprising:
a holding element at least partially formed of electrically conductive material;
a board, wherein said board comprises:
an electric circuit;
an alarm element; and
a power source that is operatively associated with said electric circuit and said alarm element;
wherein said device for prevention of card displacement is operative in an electrically closed position wherein said holding element is coupled to said board such that at least some of the electrically conducting material of said holding element is pressed by default against said board and in an electrically open position wherein said holding element and said board are generally spaced apart.

3. A device for prevention of card displacement, comprising:
a holding element at least partially formed of electrically conductive material;
a board, wherein said board comprises:
an electric circuit;
an alarm element; and
a power source that is operatively associated with said electric circuit and said alarm element;
wherein said holding element is coupled to said board such that at least some of the electrically conducting material of said holding element is pressed by default against said board, such that adjustment of said card between said holding element and said board opens said electric circuit; and wherein removal of said card therefrom closes said electric circuit.

4. A device for prevention of card displacement according to claim 3, wherein said closing of said electric circuit triggers said alarm element.

5. A device for prevention of card displacement according to claim 3, further comprising a delay mechanism that is adapted to trigger said alarm element after a predetermined time period.

6. A device for prevention of card displacement according to claim 3, wherein said board is a printed circuit board.

7. A device for prevention of card displacement according to claim 3, wherein said closing of said electric circuit triggers vibration alarm.

8. A device for prevention of card displacement according to claim 3, wherein said closing of said electric circuit triggers audible alarm.

9. A device for prevention of card displacement according to claim 3, wherein said closing of said electric circuit triggers visual alarm.

10. A device for prevention of card displacement according to claim 3, wherein said closing of said electric circuit triggers vibration alarm operatively coupled with visual alarm.

11. A device for prevention of card displacement according to claim 3, wherein said closing of said electric circuit triggers vibration alarm operatively coupled with audible alarm.

12. A device for prevention of card displacement according to claim 3, wherein said holding element is formed of generally resilient material.

13. A device for prevention of card displacement according to claim 3, wherein the shape of said holding element coupled to said board is adapted to be inserted into various shapes of carrying means.

14. A device for prevention of card displacement according to claim 2, wherein said closing of said electric circuit triggers said alarm element.

15. A device for prevention of card displacement according to claim 1, wherein said closing of said electric circuit triggers said alarm element.

16. A device for prevention of card displacement according to claim 2, further comprising a delay mechanism that is adapted to trigger said alarm element after a predetermined time period.

17. A device for prevention of card displacement according to claim 2, wherein said board is a printed circuit board.

18. A device for prevention of card displacement according to claim 2, wherein said closing of said electric circuit triggers vibration alarm.

19. A device for prevention of card displacement according to claim 2, wherein said closing of said electric circuit triggers audible alarm.

20. A device for prevention of card displacement according to claim 2, wherein said closing of said electric circuit triggers visual alarm.
